(19) United States
(12) Patent Application Publication
(10) Pub. No.: US 2004/0254799 A1
(43) Pub. Date: Dec. 16, 2004

(54) Systems and method for providing address template application programming interfaces

(76) Inventor: Shani M. Zebooker, Rockville, MD (US)

Correspondence Address: FINNEGAN, HENDERSON, FARABOW, GARRETT & DUNNER, LLP, 1300 I STREET, NW, WASHINGTON, DC, 20005, US

(21) Appl. No.: 10/312,449

(22) PCT Filed: Jun. 28, 2001
(86) PCT No.: PCT/US01/20449

(51) Int. Cl. G06F 17/60

(52) U.S. Cl. 705/1

(57) ABSTRACT

Methods and systems consistent with the principles of the present invention provide for application programming interfaces (hereinafter ‘APIs’) that receive and process multinational address information. A user can access an API for a particular country. The API provides to the user a number of fields that represent address elements. Address elements are the smallest building blocks for an address and are coded whereby each address element receives a particular code. The user completes the fields with the address information. The system receives this information and examines the address information for completeness. Once the address information is complete, the information can then be output, i.e., to store in a database, to a printer to print out an address label, or address lists.

### DESCRIPTION OF THE INVENTION RELATED APPLICATION DATA

This application is related to, and claims priority to, U.S. Provisional Application No. 60/215,118, filed Jun. 29, 2000, entitled “Systems and Methods for an Address Template Application Programming Interface” which is expressly incorporated herein by reference in its entirety.

### FIELD OF THE INVENTION

This invention relates generally to systems and methods for providing for application programming interfaces, and more specifically, to systems and methods for providing for an address template application programming interfaces.

### BACKGROUND OF THE INVENTION

Historically, companies have collected client address information in databases that were designed for collecting domestic address information. For each client address information would be stored in a legacy database in the form of strung address lines. The storage of address information in this way was generally sufficient for accessing the information and generating address labels and address lists.

However, with increasing use of the Internet, companies that have traditionally transacted business within the United States are now engaged in international transactions. The databases that were designed primarily for domestic addresses are now being called upon to store and recall international addresses to be used for delivery in other countries. Due to the differences in the address formats in different countries, companies are finding these databases entirely inadequate for the storage of multinational address information. For example, in the United States, the street address is extremely important in ensuring proper delivery. However, in other countries, there is no street address and other address information is used to identify a delivery point. Additionally, due to the changes in technology, and more specifically, to the changes in database management, the methods for interpreting the address information are inadequate to produce an accurate deliverable address anywhere in the world.

As a result, there is a need for a system or method that easily retrieves parsed information that can accommodate modern and legacy databases in order to store and generate deliverable multinational addresses.

### SUMMARY OF THE INVENTION

In accordance with the principles of the invention, as embodied and broadly described herein, methods and systems consistent with the principles of the present invention provide for processing multinational address information, including receiving a request for an address input interface designating a geographical region; providing an address input interface for the region, wherein the address input interface includes a set of fields representing a location designation; receiving location designation information corresponding to the set of fields to designate the location; and outputting the location designation information in conformity with a format corresponding to the geographical region.

Additional features and principles of the present invention will be set forth in part in the description which follows, and in part will be obvious from the description, or may be learned by practice of the invention. The features and principles of the present invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute apart of this specification, illustrate several embodiments of the invention and together with the description, serve to explain the principles of the invention, and, together with the description, explain the features and aspects of the invention. In the drawings,

FIG. 1 is an exemplary diagram of a system environment in which systems and methods, consistent with the principles of the present invention, can be implemented;

FIG. 2 is an exemplary diagram of the main components of a client computer, consistent with the principles of the present invention;

FIG. 3 is an exemplary diagram of the main components of a server computer consistent with the principles of the present invention;

FIG. 4 is an exemplary diagram of an application programming interface, consistent with the principles of the present invention;

FIG. 4A depicts an exemplary diagram of a address input interface for Argentina, consistent with the principles of the present invention;

FIG. 4B depicts an exemplary diagram of a address input interface for Australia, consistent with the principles of the present invention;

FIG. 4C depicts an exemplary diagram of a address input interface for Brazil, consistent with the principles of the present invention;

FIG. 4D depicts an exemplary diagram of a address input interface for Chile, consistent with the principles of the present invention;

FIG. 4E depicts an exemplary diagram of a address input interface for China, consistent with the principles of the present invention;

FIG. 4F depicts an exemplary diagram of a address input interface for France, consistent with the principles of the present invention;

FIG. 4G depicts an exemplary diagram of a address input interface for Hong Kong, consistent with the principles of the present invention;

FIG. 4H depicts an exemplary diagram of a address input interface for Japan, consistent with the principles of the present invention;

FIG. 4I depicts an exemplary diagram of a address input interface for Singapore, consistent with the principles of the present invention;

FIG. 5 depicts an exemplary flow chart of a method for providing address information, consistent with the principles of the present invention; and

FIG. 6 depicts an exemplary flow chart of a method for receiving and interpreting address information, consistent with the principles of the present invention.

### DESCRIPTION OF THE EMBODIMENTS

Reference will now be made in detail to the present invention, an examples of which are illustrated in the accompanying drawings. Wherever possible, the same reference numbers will be used throughout the drawings to refer to the same or like parts.

Overview

Methods and systems consistent with the principles of the present invention provide for application programming interfaces (hereinafter ‘APIs’) that receive and process multinational address information. An API can provide an interface between a high-level language and utilities and services. A user can access an API for a particular country. The API provides to the user a number of fields that represent address elements. Address elements are the smallest building blocks for an address and are coded whereby each address element receives a particular code. The user completes the fields with the address information. The system receives this information and examines the address information for completeness. Once the address information is complete, the information can then be output, i.e., to store in a database, to a printer to print out an address label, or address lists.

System Architecture

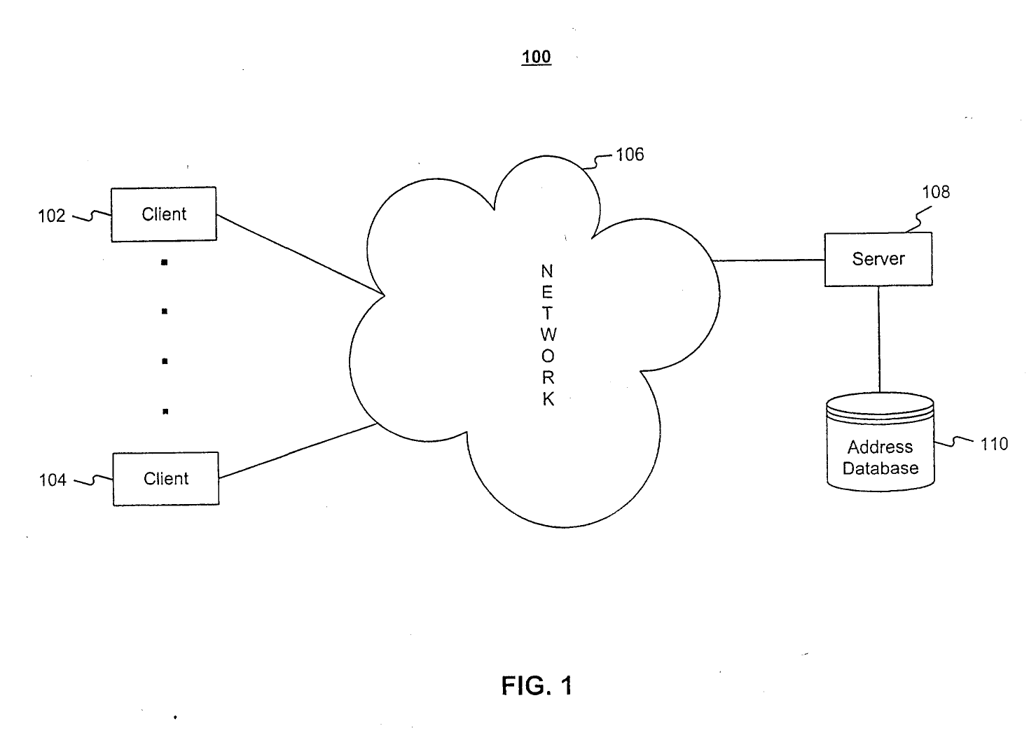

FIG. 1 is an exemplary diagram of the components of a system environment 100 in which systems and methods consistent with the principles of the present invention may be implemented. The components of system 100 can be implemented through any suitable combination of hardware, software, and/or firmware. As shown in FIG. 1, system 100 includes a number of devices, including a plurality of client computers 102 and 104, a network 106, a server 108, and an address database 110. Client computers 102 and 104 may be implemented as personal computers (hereinafter ‘PCs’) or workstations or, in the alternative, may be servers through which client computers can access network 106. While only two client computers 102 and 104 are illustrated in FIG. 1, any number of client computers can be connected to network 106.

Network 106 can be implemented through any suitable combination of communication networks including, for example, the Internet, or as any other type of network including a wide-area network or a local-area network. Client computers 102 and 104 can access server 108 through network 106.

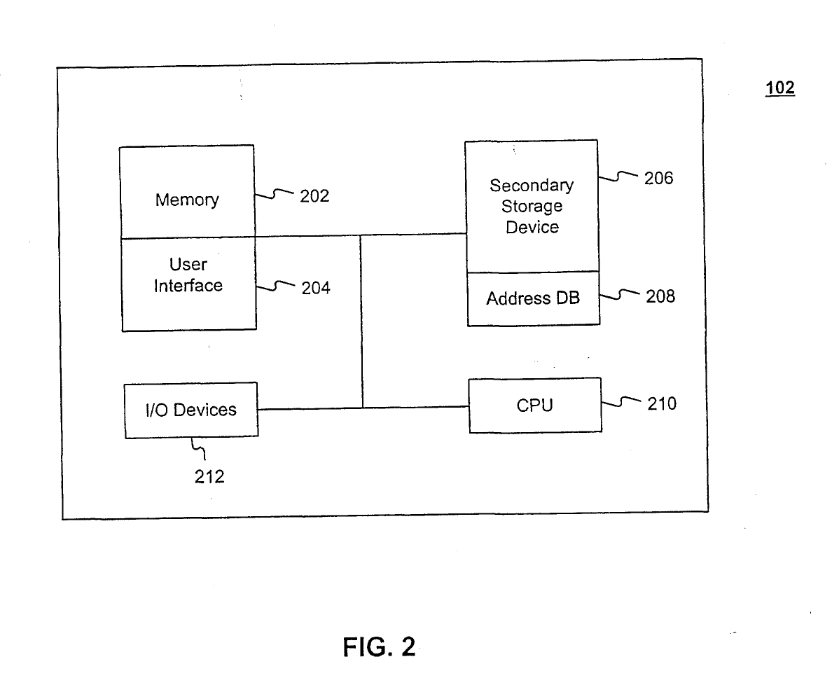

FIG. 2 depicts an exemplary diagram of client computer 102 that may be implemented in system environment 100, consistent with the principles of the present invention. It can be appreciated that the configuration of client computer 102 can be similar for all client computers 102 and 104. Client computer 102 includes a memory 202, a user interface 204, a secondary storage device 206, an address database 208, a central processing unit 210, and input/output devices 212. Input/output devices 212 may include a keyboard, a mouse, a display, a storage device, and/or a printer. User interface 204 may be implemented as a conventional browser application, including conventional browser applications available from Microsoft or Netscape. A user can launch user interface 204 through input/output devices 212 and access server 108 through network 106. Address database 208 may be implemented as a conventional database application and can be used for storing address information temporarily while accessing server 108. It can be appreciated that address database 208 may reside at server 108.

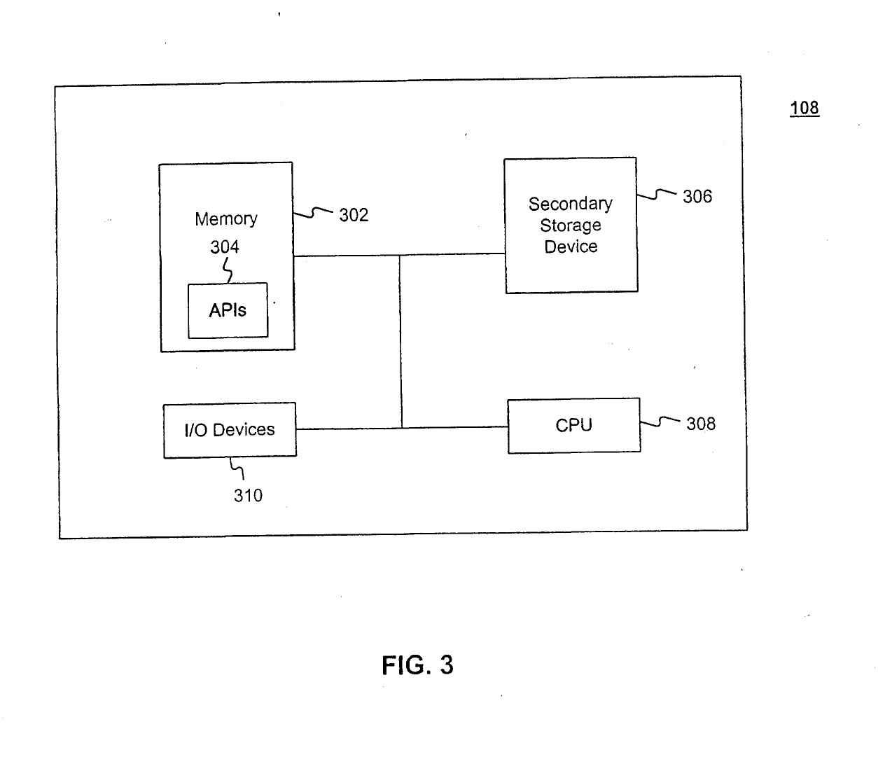

FIG. 3 depicts an exemplary diagram of server 108 that may be implemented in system environment 100, consistent with the principles of the present invention. As shown in FIG. 3, server 108 includes a memory 302, APIs 304 contained in memory 302, a secondary storage device 306, a central processing unit 308, and input/output devices 310. Server 108 is connected to network 106 and may be accessed by client computers 102 and 104 for accessing an APIs 304 for providing address information wherein server 108 processes the information and outputs the information, for example, to a database for storage, or to a printer to print out address labels or address lists. It may be appreciated by one of ordinary skill in the art that the APIs may reside on client computers 102 and 104.

Coding Address Elements

An address structure maybe broken down into “address elements”, i.e., house numbers, streets, post boxes, directions, street types, cities, countries, post codes, states, provinces etc. As set forth above, the APIs use address elements as the building blocks for generating addresses.

Every type of address in every country may be broken down into address elements and a unique code may be assigned for each address element. For example, “123 Main Street, Vienna, Va., 22181” contains 6 address elements, 1) “123” is a house number and may be assigned code 101; 2) “Main” is the street name and may be assigned code 103; 3) “Street” is a street type and may be assigned “102”; 4) “Vienna” is a city and maybe assigned code 107; and 5) “Virginia” is a state and maybe assigned code 108; 6) “22181” is a zip code and may be assigned code 110. It can be appreciated by one of ordinary skill in the art that different types of codes may be assigned to the address elements, including alpha-numeric characters.

By coding address elements, the individual elements maybe stored as separate data elements and can be brought together to create a mailing address specific to the immediate mailing purpose and in a format that is deliverable by the destination postal service provider. Further, codifying address elements enables the storage of multinational address in a single database.

Address Template APIs

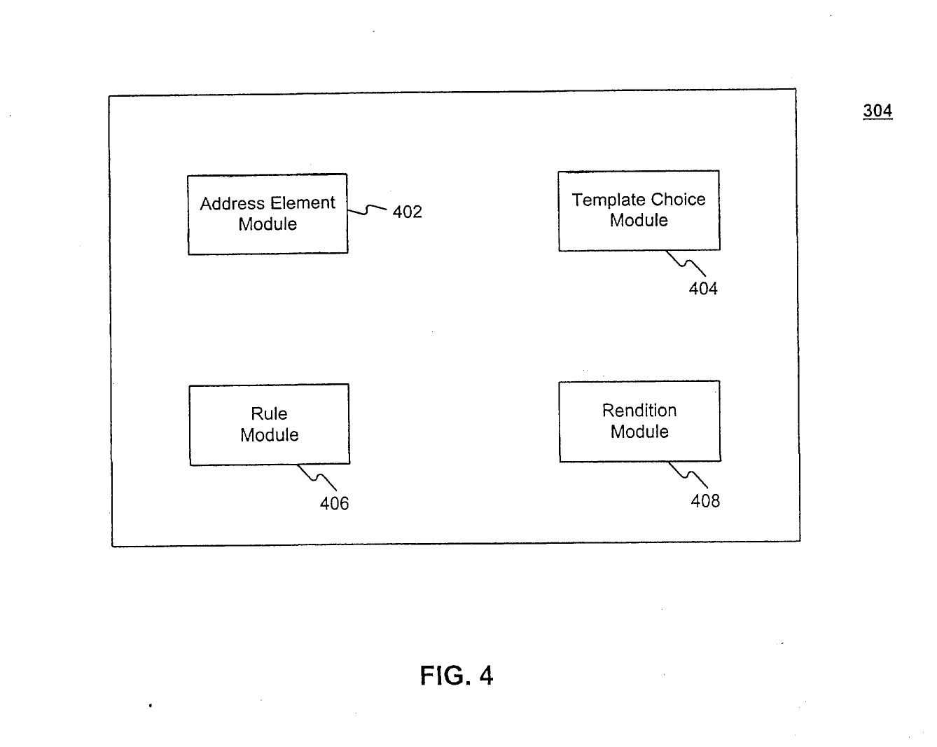

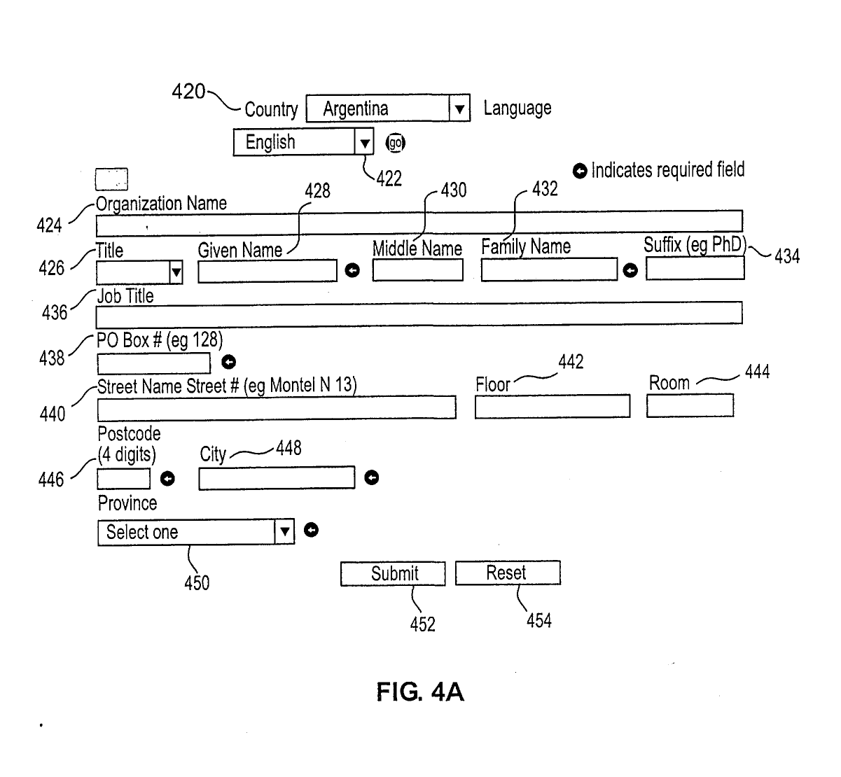

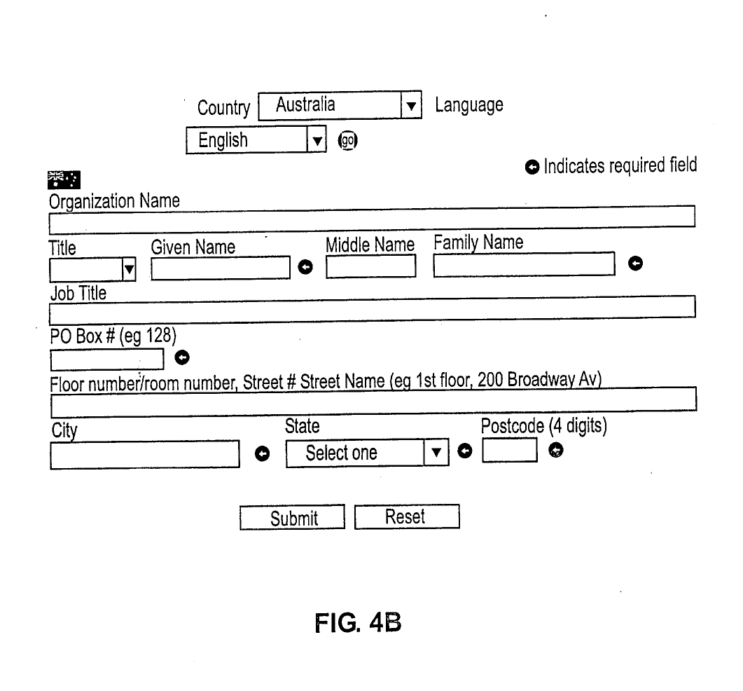

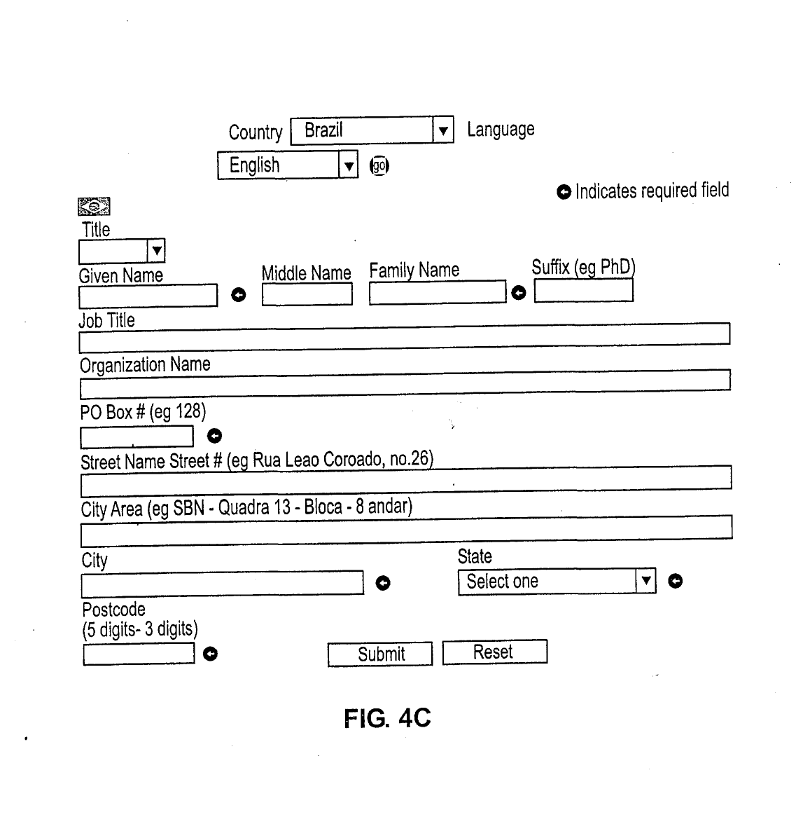

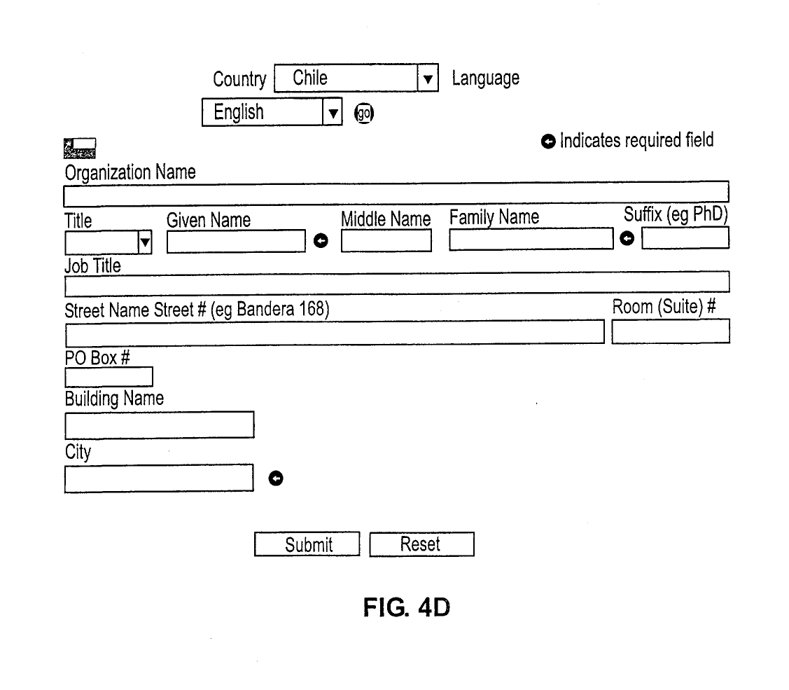

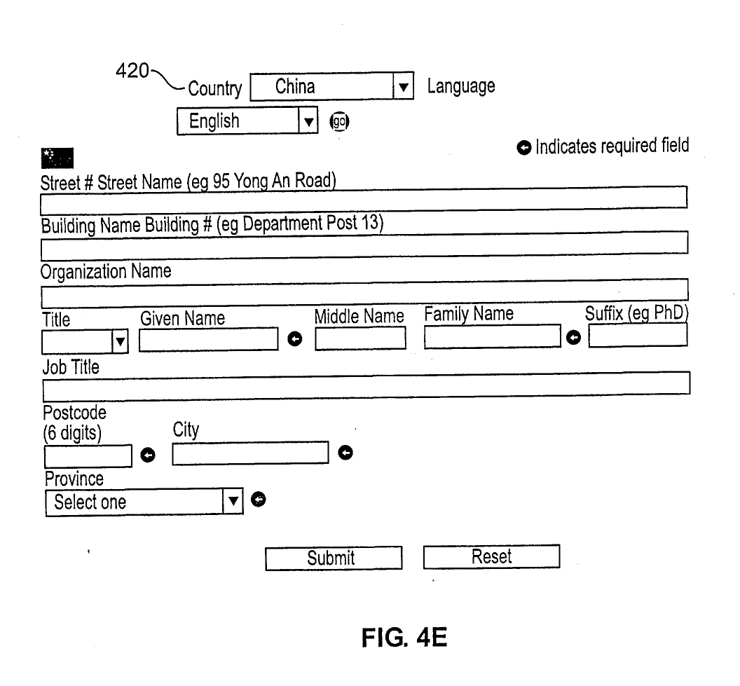

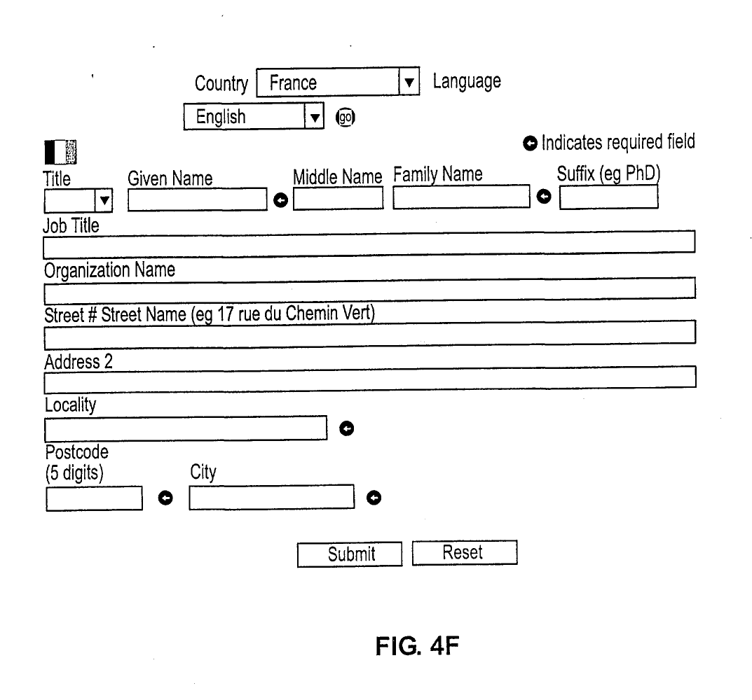

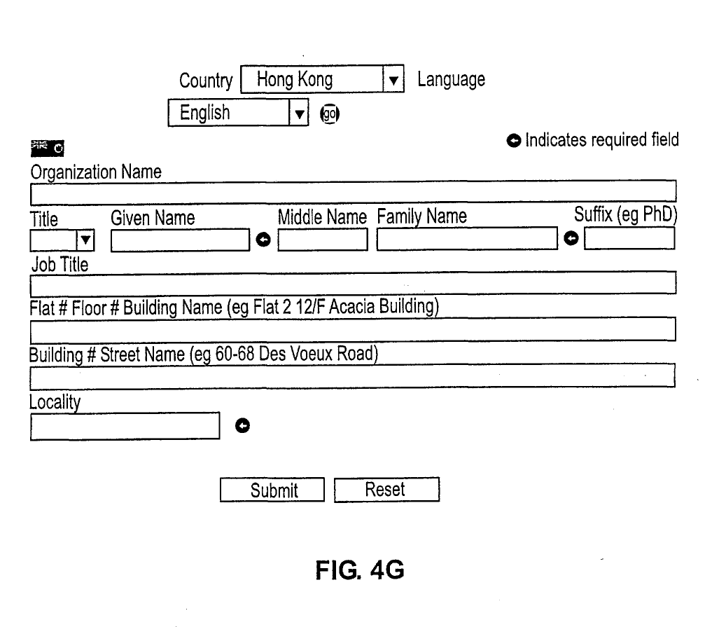

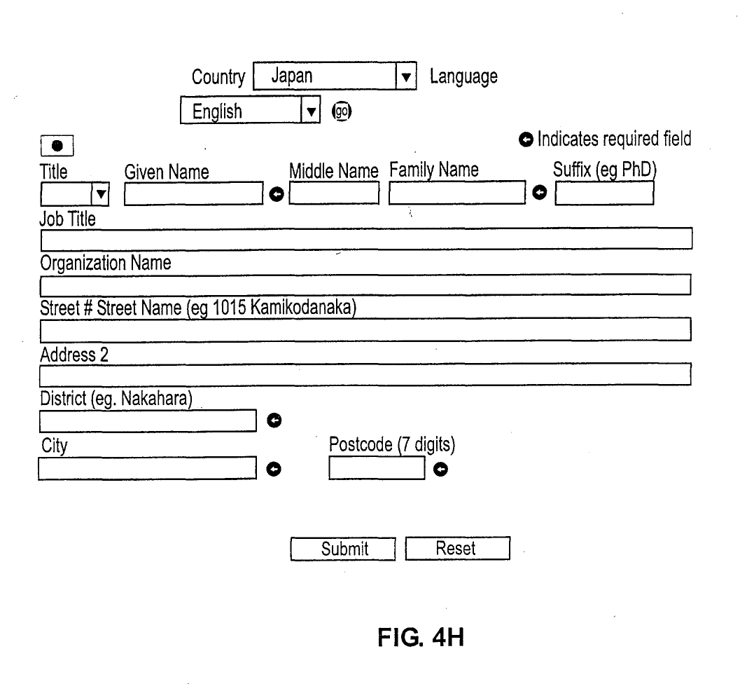

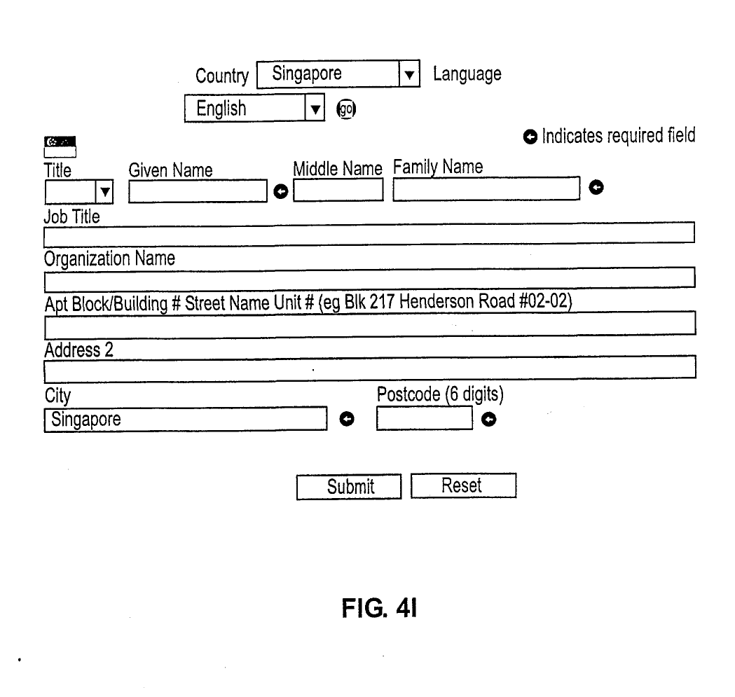

FIG. 4 depicts an exemplary detailed diagram of components included in APIs 304 that may be used in system 100, consistent with the principles of the present invention. APIs 304 contain an address element interface module 402, a template choice module 404, a rule module 406, and a rendition module 408.

Rule Module 406 contains logical rules regarding completeness of the address information based on the template that is used. A template is comprised of formatted codes that specify the order of the address elements such that, when the address elements are substituted for the codes, the result represents a deliverable address. For example, if a user enters address information and neglects to enter a building number, but enters a street, and the template requires both a building number and a street, rule module 406 would notify the user that additional address information is required. Further, rule module 406 contains logical rules regarding certain output options. For example, if an address label is to be printed, and the address information contains “P.O. Box”, rule module 406 may contain a rule that prints out “Post Office Box” on the label.

Address element interface module 402 contains address input interfaces for providing to the user a number of fields representing address elements corresponding to the country a user has selected. Address element interface module 402 determines which fields have been populated by the user and passes this information to template choice module.

FIGS. 4A-4I depict exemplary address input interfaces for various countries as may be displayed on client computers 102 and 104. FIG. 4A depicts an exemplary diagram of a address input interface for Argentina, consistent with the principles of the present invention. As shown in FIG. 4A, an exemplary address input interface is depicted. A country field 420 contains a pull-down menu wherein the country of Argentina is selected. A language field 422 contains a pull-down menu wherein the English language is selected. As such, the remaining fields contained in the address input interface correspond to the address information that may be incorporated in addresses in Argentina. The remaining address input interface contains an organization field 424, a title field 426, a given name field 428, a middle name field 430, a family name field 432, a job title field 436, a PO Box field 438, a street name/street number field 440, a floor field 442, a room field 444, a postcode field 446, a city field 448, a province field 450 (containing a pull-down menu), a submit button 452 and a reset button 454. Thus, a user accessing this address input interface would enter the address information corresponding to the address that the user wanted to provide, and then selects the submit 452 button to submit the information.

It can be appreciated by one of ordinary skill in the art that the address input interface can be submitted by the user in a variety of ways, including a web-based browser utilizing HTML such as Internet Explorer, utilizing custom software operating on client computer 102 or 104, etc.

FIGS. 4B-4I contain address input interfaces that operate similarly to the address input interface as described in 4A, however each depicts address input interfaces for different countries and the actual address elements may vary from country to country. Specifically, FIGS. 4B-4I depicts address input interfaces for Australia, Brazil, Chile, China, France, Hong Kong, Japan, and Singapore, respectively. It can be appreciated by one of ordinary skill in the art that the address input interfaces may appear in various formats, provided that the address customary to that country is conveyed in the interface.

Template choice module 404 (FIG. 4) contains at least one template for each country. The template contains information, including codes corresponding to address elements, regarding the format of an address within that country. After receiving information from address element interface module 402, template choice module determines which template to use based on the address information provided by the user. For example, if the user entered the “United States” as the country, and provided “PR” as a state, the Puerto Rican template would be used. Template choice module 404 then codes the data contained in each of the fields that have been entered by assigning a pre-defined code to the data in each field. These codes, correspond to the position or location of the data when the address information in output.

Rendition module 408 contains rules regarding formatting of address elements. The formatting rules dictate the appearance of an address when it is output, and could be used to properly order, space, and abbreviate an address. For example, if an address has more information than a label has space, certain address elements need to be shortened. However, depending upon what country the address is in, if certain address elements are incorrectly shortened, the address may be undeliverable. Thus, the rendition module may contain rules regarding abbreviations for each country. For example, in the United States, if the address is “123 North Maple Avenue”, the rendition module may contain a rule that address element “Avenue” can be shortened to “Ave”.

Entering Address Information

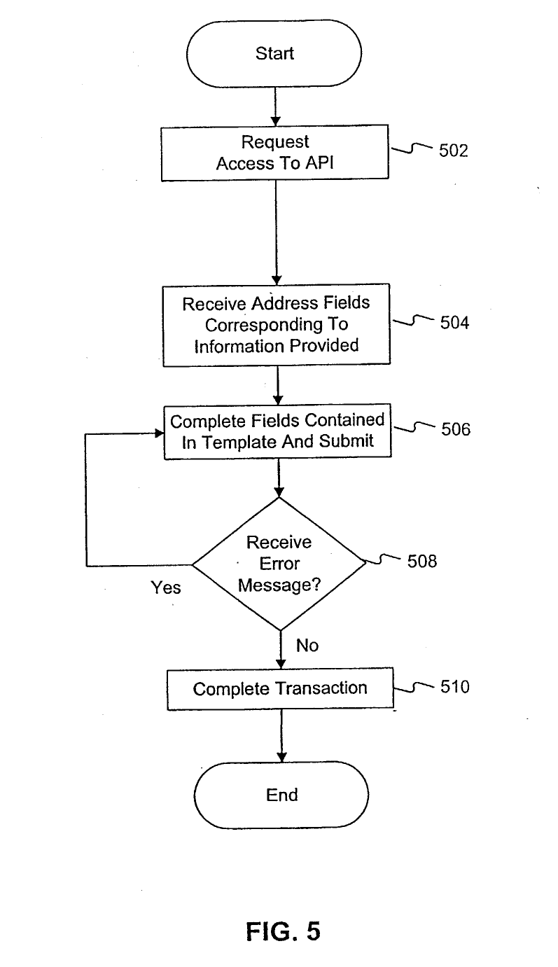

FIG. 5 depicts an exemplary flow chart of the steps performed by client computers 102 and 104 for providing address information, consistent with the principles of the present invention. Client computers 102 and 104, using user interface 204, receive user input designating a geographical region (e.g., a country), access server 108 through network 106, and request access to an API by providing the country of address the user is going to provide (Step 502). Once the particular API is accessed, corresponding to the particular country the user selected, the client computer 102 or 104 receives and displays an address input interface containing a plurality of fields to populate using the address information (Step 504). The user then inputs the appropriate address information in each field and submits the completed information (Step 506). If the user receives an error message (Step 508, yes) the user must add or correct the required information and submit the information. If an error message was not received (Step 508, no), the transaction is completed (Step 510).

Receiving and Processing the Address Information

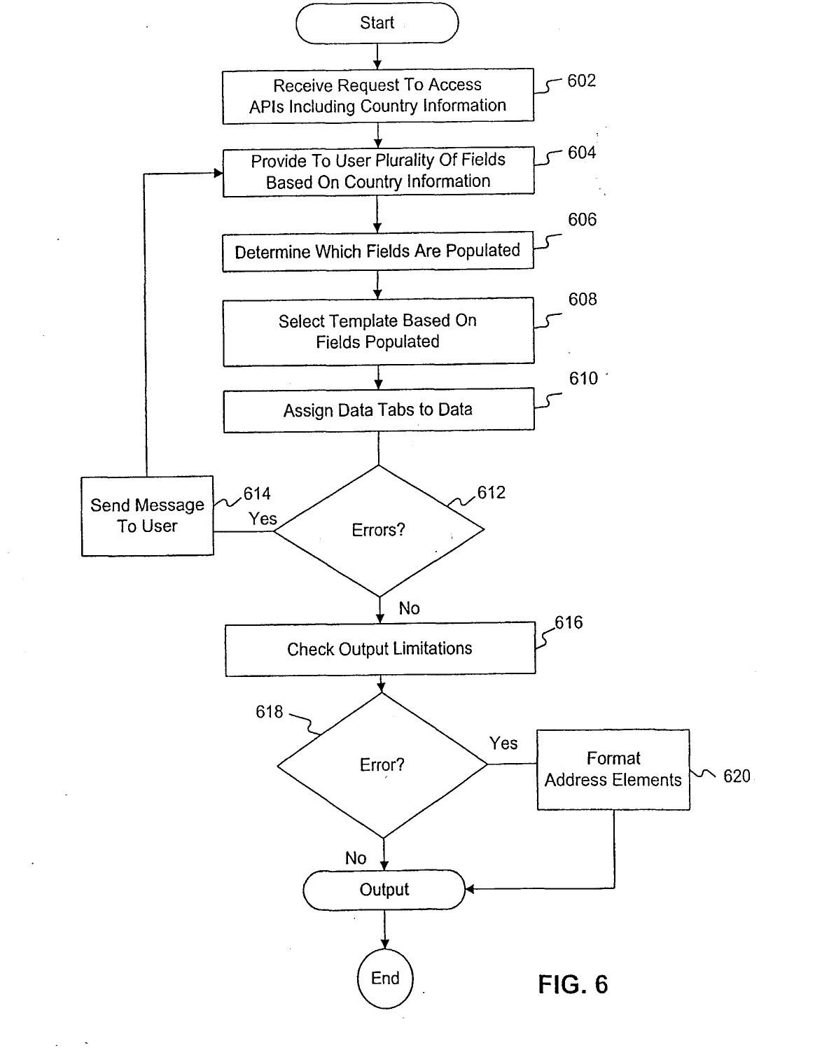

FIG. 6 depicts a flow diagram of the steps performed by server 108 for receiving and processing the address information. Server 108 receives a request from client computer 102 or 104 to access APIs and enter address information (Step 602). Included in this request is the designation of a country. Address element interface module 402 receives this request, including the country information, and provides an address input interface containing a plurality of fields corresponding to address elements of that particular country (Step 604). Once these fields are populated and submitted for processing by the user, address element interface module receives this information and determines which fields have been populated. The address element interface module 402 then assigns the address data with codes corresponding to the field the data was entered in. The data, together with the codes, are passed to template choice module 404 (Step 606).

Template choice module 404 (FIG. 4) examines the information and determines which template to use to compare the address information provided by the user (Step 608) and assigns codes to the data corresponding to each field that is populated by the user (Step 610). The rule module 406 (FIG. 4) then compares the template with the address information provided by the user to determine if any errors have occurred, i.e., incorrect information, or not enough information, has been provided (Step 612). If any errors have occurred (Step 612, yes), then an error message is sent to the user (Step 614) and processing returns to Step 604. If no errors have occurred (Step 612, no), then the limitations of the output are considered (Step 616). For example, if the address information is being printed out on a label that only contains 20 characters on the street address line, and the address information the user provided for the street address line contains 24 characters, an error would occur if the system determines that an error has occurred (Step 618, yes), rendition module 408 (FIG. 4) would examine the address information and format the address information accordingly, for example, truncate certain address elements (Step 620) and the address information is then output (Step 622). If no error occurs (Step 618, no), the address information is directly output without any truncation.

Applications

The address template APIS, consistent with the present invention, can be applied in any type of situation where address information is used. For example, a client computer accessing a merchant web site on the Internet may request to purchase an item at the merchant's web site. Upon checking out, the user would be required to enter address information for shipping or billing purposes. The user would be requested to enter the country of the address the user wished to ship to. The processing of the address information would proceed as discussed above. It can be appreciated by one of ordinary skill in the art that if the customer is shopping at a country specific web site, that country would be the country selection for accessing the appropriate interface.

Modifications and adaptations of the present invention will be apparent to those skilled in the art from consideration of the specification and practice of the invention disclosed herein. The foregoing description of an implementation of the invention has been presented for purposes of illustration and description. It is not exhaustive and does not limit the invention to the precise form disclosed. Modifications and variations are possible in light of the above teachings or may be acquired from the practicing of the invention. For example, the described implementation includes software, but systems and methods consistent with the present invention may be implemented as a combination of hardware and software or in hardware alone. Additionally, although aspects of the present invention are described for being stored in memory, one skilled in the art will appreciate that these aspects can also be stored on other types of computer-readable media, such as secondary storage devices, for example, hard disks, floppy disks, or CD-ROM; the Internet or other propagation medium; or other forms of RAM or ROM. It is intended that the specification and examples be considered as exemplary only, with a true scope and spirit of the invention being indicated by the following claims.

What is claimed is:

1. A method for processing multinational address information, comprising the steps of:
receiving a request for an address input interface designating a geographical region;
providing an address input interface for the region, wherein the address input interface includes a set of fields representing a location designation;
receiving location designation information corresponding to the set of fields to designate the location; and
outputting the location designation information in conformity with a format corresponding to the geographical region.

2. The method of claim 1, wherein outputting the location designation information includes outputting the location designation information to a database.

3. The method of claim 1, wherein outputting the location designation information includes outputting the location designation information to an address label.

4. The method of claim 1, wherein outputting the location designation information includes outputting a list of location designations.

5. A method for providing for address template application programming interfaces, comprising:
receiving a request to access an application programming interface designating a region wherein the application programming interface includes an address template;
providing a plurality of fields representing a plurality of address elements corresponding to the region;
receiving data corresponding to at least one of the plurality of fields;
assigning each of the data corresponding to the at least one of the plurality of fields representing a plurality of address elements with a code;
processing the data corresponding to the at least one of the plurality of fields; and
outputting an address.

6. The method of claim 5, wherein processing the data further includes:
comparing the data with the address template; and
determining whether additional information is needed based on the comparison.

7. The method of claim 5, wherein outputting the address includes:
determining that the output of the address is to be stored in a database; and
storing the data in the database according to the code assigned to the data

8. The method of claim 5, wherein outputting the address includes:
determining that the output of the address is to a printer to print an, address label;
formatting the address according to the code assigned to the data; and
printing the address label.

9. A method for processing multinational address information, comprising the steps of:
sending a request, by a client computer, for an address input interface designating a geographical region;
receiving the request and providing an address input interface for the region, by a server computer, wherein the address input interface includes a set of fields representing a location designation;
populating the set of fields in the address input interface with location designation information, by a client computer; and
receiving the location designation information, by the server computer, and outputting the location designation information in conformity with a format corresponding to the geographical region.

10. The method of claim 9, wherein outputting the location designation information includes outputting the location designation information to a database.

11. The method of claim 9, wherein outputting the location designation information includes outputting the location designation information to an address label.

12. The method of claim 9, wherein outputting the location designation information includes outputting a list of location designations.

13. An apparatus for processing multinational address information, comprising:
a receiving module configured to receive a request for an address input interface designating a geographical region;
a providing module configured to provide an address input interface for the region, wherein the address input interface includes a set of fields representing a location designation;
a receiving module configured to receive location designation information corresponding to the set of fields to designate the location; and
an outputting module configured to output the location designation information in conformity with a format corresponding to the geographical region.

14. The apparatus of claim 13, wherein the outputting module configured to output the location designation information includes outputting the location designation information to a database.

15. The apparatus of claim 13, wherein the outputting module configured to output the location designation information includes outputting the location designation information to an address label.

16. The apparatus of claim 13, wherein the outputting module configured to output the location designation information includes outputting a list of location designations.

17. An apparatus for providing for address template application programming interfaces, comprising:
a receiving module configured to receive a request to access an application programming interface designating a region wherein the application programming interface includes an address template;
a providing module configured to provide a plurality of fields representing a plurality of address elements corresponding to the region;
a receiving module configured to receive data corresponding to at least one of the plurality of fields;
an assigning module configured to assign each of the data corresponding to the at least one of the plurality of fields representing a plurality of address elements with a code;
a processing module configured to process the data corresponding to the at least one of the plurality of fields; and
an outputting module configured to output an address.

18. The apparatus of claim 17, wherein the processing module configured to process the data further includes:
a comparing module configured to compare the data with the address template; and
a determining module configured to determine whether additional information is needed based on the comparison.

19. The apparatus of claim 17, wherein the outputting module configured to output the address includes:
a determining module configured to determine that the output of the address is to be stored in a database; and
a storing module configured to store the data in the database according to the code assigned to the data.

20. The apparatus of claim 17, wherein the outputting module configured to output the address includes:
a determining module configured to determine that the output of the address is to a printer to print an address label;
a formatting module configured to format the address according to the code assigned to the data; and
a printing module configured to print the address label.

21. An apparatus for processing multinational address information, comprising:
a sending module configured to send a request, by a client computer, for an address input interface designating a geographical region;
a receiving module configured to receive the request and providing an address input interface for the region, by a server computer, wherein the address input interface includes a set of fields representing a location designation;
a populating module configured to populate the set of fields in the address input interface with location designation information, by a client computer; and
a receiving module configured to receive the location designation information, by the server computer, and outputting the location designation information in conformity with a format corresponding to the geographical region.

22. The apparatus of claim 21, wherein the outputting module configured to output the location designation information includes outputting the location designation information to a database.

23. The apparatus of claim 21, wherein the outputting module configured to output the location designation information includes outputting the location designation information to an address label.

24. The apparatus of claim 21, wherein the outputting module configured to output the location designation information includes outputting a list of location designations.

25. A computer-readable medium containing instructions for processing multinational address information, comprising:
receiving a request for an address input interface designating a geographical region;
providing an address input interface for the region, wherein the address input interface includes a set of fields representing a location designation;
receiving location designation information corresponding to the set of fields to designate the location; and
outputting the location designation information in conformity with a format corresponding to the geographical region.

26. The computer-readable medium of claim 25, wherein outputting the location designation information includes outputting the location designation information to a database.

27. The computer-readable medium of claim 25, wherein outputting the location designation information includes outputting the location designation information to an address label.

28. The computer-readable medium of claim 25, wherein outputting the location designation information includes outputting a list of location designations.

29. A computer-readable medium containing instructions for providing for address template application programming interfaces, comprising:
receiving a request to access an application programming interface designating a region wherein the application programming interface includes an address template;
providing a plurality of fields representing a plurality of address elements corresponding to the region;
receiving data corresponding to at least one of the plurality of fields;
assigning each of the data corresponding to the at least one of the plurality of fields representing a plurality of address elements with a code;
processing the data corresponding to the at least one of the plurality of fields; and
outputting an address.

30. The computer-readable medium of claim 29, wherein processing the data further includes:
comparing the data with the address template; and
determining whether additional information is needed based on the comparison.

31. The computer-readable medium of claim 29, wherein outputting the address includes:
determining that the output of the address is to be stored in a database; and
storing the data in the database according to the code assigned to the data.

32. The computer-readable medium of claim 29, wherein outputting the address includes:
determining that the output of the address is to a printer to print an address label;
formatting the address according to the code assigned to the data; and
printing the address label.

33. A computer-readable medium containing instructions for processing multinational address information, comprising the steps of:
sending a request, by a client computer, for an address input interface designating a geographical region;
receiving the request and providing an address input interface for the region, by a server computer, wherein the address input interface includes a set of fields representing a location designation;
populating the set of fields in the address input interface with location designation information, by a client computer; and
receiving the location designation information, by the server computer, and outputting the location designation information in conformity with a format corresponding to the geographical region.

34. The computer-readable medium of claim 33 wherein outputting the location designation information includes outputting the location designation information to a database.

35. The computer-readable medium of claim 33, wherein outputting the location designation information includes outputting the location designation information to an address label.

36. The computer-readable medium of claim 33, wherein outputting the location designation information includes outputting a list of location designations.
